(19) United States
(12) Patent Application Publication
(10) Pub. No.: US 2008/0191862 A1
(43) Pub. Date: Aug. 14, 2008

(54) DATA CARRIER

(76) Inventor: Koji TERAOKA, Osaka (JP)

Correspondence Address: MCDERMOTT WILL & EMERY LLP, 600 13TH STREET, NW, WASHINGTON, DC, 20005-3096, US

(21) Appl. No.: 12/029,965

(22) Filed: Feb. 12, 2008

(30) Foreign Application Priority Data
Feb. 14, 2007 (JP) 2007-033944

(51) Int. Cl. G08B 29/00

(52) U.S. Cl. 340/506

(57) ABSTRACT

A level determination section determines the degree of need to monitor a sensor (how often monitoring should be performed) in accordance with a plurality of conditions set based on one or both of a measured quantity obtained from the sensor and the rate of change of the measured quantity, and outputs a determination signal according to the determination result. An oscillator controls the frequency of a clock signal output therefrom, in accordance with the determination signal, and supplies the clock signal to a data processing/recording section which performs data processing on the measured quantity and command information.

### CROSS REFERENCE TO RELATED APPLICATION

The disclosure of Japanese Patent Application No. 2007-033944 filed on Feb. 14, 2007 including specification, drawings and claims is incorporated herein by reference in its entirety.

### BACKGROUND OF THE INVENTION

1. Field of the Invention

The present invention relates to a data carrier (for example, a non-contact IC card, a non-contact tag, etc.) which communicates with a reader/writer.

2. Description of the Related Art

When attached to commercial products, etc., non-contact tags, which are one type of data carrier, can be expected to be used to control the distribution and quality of the products, and so on. Particularly in recent years, in the non-contact tag market, there is an increasing need for high-value-added non-contact tags equipped with a sensor. For example, a non-contact tag equipped with a temperature sensor is expected to perform product temperature control and the like.

One type of sensor-equipped non-contact tag processes a measured quantity output from the sensor, only when the sensor-equipped non-contact tag obtains power from a signal received from a reader/writer and exists in the communication region of the reader/writer. Other type of sensor-equipped non-contact tag is provided with a battery and always monitors a measured quantity output from the sensor regardless of the presence or absence of a reader/writer.

The non-contact tag of the type that obtains power from the received signal is required to lower power consumption, because a communication distance from the reader/writer has to be kept. The non-contact tag of the type that obtains power from a battery is also required to reduce power consumption, because the life of the battery needs to be increased.

Examples of non-contact tags that have achieved power savings include one in which a power supply potential and the frequency of a clock that are supplied to a central processing unit are changed in response to the occurrence of an event signal (see Japanese Laid-Open Publication No. 2005-268768, for example).

Depending on the sensor's measured quantity, a sensor-equipped non-contact tag sometimes needs to operate at high speed so as to perform a large amount of data processing, but other times may reduce the processing speed because the amount of data processing is small. In the case where the processing speed may be lowered, if the clock frequency can be reduced, a greater reduction in power consumption is expected.

Nevertheless, the method in which an event signal is monitored as described above does not optimize the clock frequency, and thus cannot achieve a further reduction in power consumption by optimizing the clock frequency with respect to the sensor's measured quantity.

### SUMMARY OF THE INVENTION

In view of the above problem, the present invention was made and it is therefore an object of the invention to achieve a greater reduction in power consumption in a data carrier.

In order to achieve the object, the frequency of a clock signal is set according to the degree of need to monitor a sensor.

For example, an inventive data carrier which communicates with a reader/writer includes: a sensor; a level determination section for determining the degree of need to monitor the sensor in accordance with a plurality of conditions set based on one or both of a measured quantity obtained from the sensor and the rate of change of the measured quantity, and outputting a determination signal according to a result of the determination; a receiving section for receiving command information from the reader/writer; a data processing/recording section for performing data processing on the measured quantity and the command information; a transmitting section for transmitting a signal corresponding to a result of the data processing to the reader/writer; and an oscillator for supplying a clock signal at least to the data processing/recording section, wherein the oscillator is configured so that the oscillation frequency thereof is controlled in accordance with the determination signal.

### BRIEF DESCRIPTION OF THE DRAWINGS

FIG. 1 is a block diagram illustrating the structure of a data carrier 100 according to a first embodiment.

FIG. 2 is a block diagram illustrating the structure of a data carrier 200 according to a second embodiment.

FIG. 3 is a block diagram illustrating the structure of a data carrier 300 according to a third embodiment.

### DETAILED DESCRIPTION OF THE INVENTION

Hereinafter, the preferred embodiments of the invention will be described with reference to the accompanying drawings. In the following embodiments, components having the same functions as those already described are identified by the same reference numerals, and the description thereof will be omitted.

### First Embodiment of the Invention

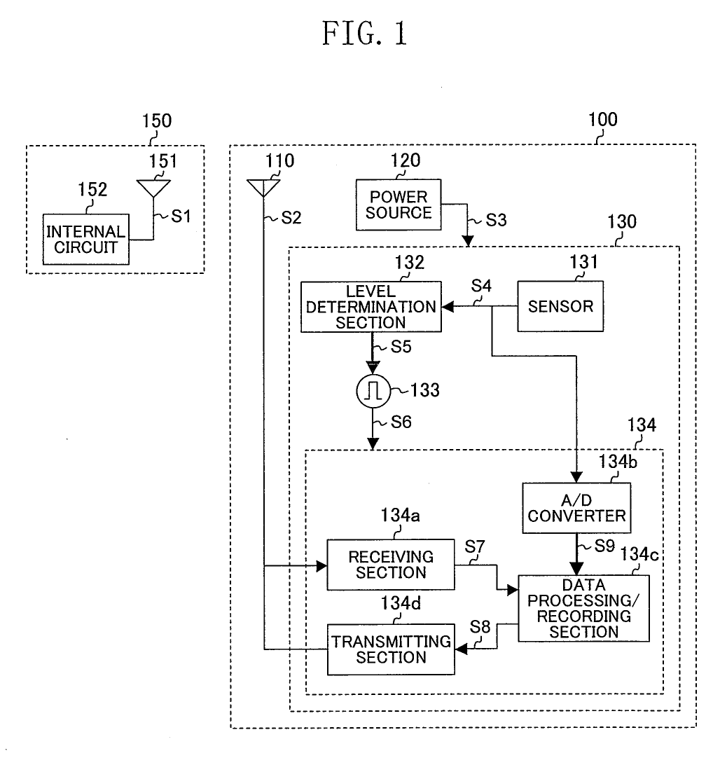

FIG. 1 is a block diagram illustrating the structure of a data carrier 100 according to a first embodiment of the invention. In FIG. 1, a reader/writer 150 is also illustrated with which the data carrier 100 communicates.

Specifically, the data carrier 100 is a non-contact tag, for example, and when attached to a commercial product, etc., the data carrier 100 is used to control the distribution and quality of the product, and so forth.

The reader/writer 150 is a device which exchanges information with the data carrier 100, and includes an internal circuit 152 and an antenna 151.

The internal circuit 152 generates data and commands (which will be collectively called command information) to be sent to the data carrier 100, and processes data received from the data carrier 100. The antenna 151 is used when two-way wireless communication with the reader/writer 150 is performed. The internal circuit 152 is electrically connected with the antenna 151 and conducts two-way communication with the data carrier 100 by using a transmitted/received signal S1.

### The Structure of the Data Carrier 100

As shown in FIG. 1, the data carrier 100 includes an antenna 110, a power source 120, and an operation section 130.

The antenna 110 is used to perform two-way wireless communication with the reader/writer 150.

The power source 120 supplies power S3 to the operation section 130. In this embodiment, the power source 120 is a battery.

The operation section 130 is the main body for exchanging information with the reader/writer 150. The operation section 130 incorporating a sensor monitors a quantity measured by the sensor to perform predetermined data processing.

Specifically, the operation section 130 includes a sensor 131, a level determination section 132, an oscillator 133, and a communication/data processing section 134.

In this embodiment, the sensor 131 is a temperature sensor. The sensor 131 converts a measured quantity (i.e., a measured temperature) to a voltage level signal and outputs, as a sensor signal S4, the voltage level signal to the level determination section 132 and to the communication/data processing section 134.

The level determination section 132 determines which of predetermined conditions (which will be described later) the temperature measured by the sensor 131 satisfies, and according to the determination results, outputs a signal (a determination signal S5) for controlling the oscillation frequency of the oscillator 133. In controlling the oscillation frequency, the oscillation operation of the oscillator 133 may also be stopped so as to make the oscillation frequency become zero.

The conditions described above are used to determine the degree of need to monitor the sensor (i.e., how often monitoring should be performed). In this embodiment, the following three conditions are set: a first condition in which the measured temperature is within a temperature range (e.g., the measured temperature is equal to or higher than 30° .) indicating that changes in the measured temperature should be observed most frequently, a second condition in which the measured temperature is within a temperature range (e.g., the measured temperature is equal to or higher than 20° C. but lower than 30° C.) indicating that changes in the measured temperature should be observed less frequently, and a third condition in which the measured temperature is within a temperature range (e.g., the measured temperature is lower than 20° C.) indicating that changes in the measured temperature should be observed least frequently. That is, the level determination section 132 determines the degree of need to monitor the sensor (i.e., how often monitoring should be performed) according to the temperature measured by the sensor 131.

In this example, since it is sufficient for the level determination section 132 to output the three different determination results to the oscillator 133, the determination signal S5 may be 2 bits wide.

The oscillator 133 supplies a clock signal (a clock signal S6) to the communication/data processing section 134. The oscillator 133 sets the oscillation frequency and the on or off of the oscillation operation in accordance with the determination signal S5. In this example, when the determination signal S5 corresponds to the first condition, the oscillation frequency is set to the highest level, followed by the level in the case of the second condition and the level in the case of the third condition in this order.

In cases where the third condition, for example, is satisfied, if the communication/data processing section 134 does not need to operate at all or the like, power supply to the oscillator 133 may be shut off so as to stop the output of the clock signal from the oscillator 133.

The communication/data processing section 134 has the function of exchanging information with the reader/writer 150 via the antenna 110 and the function of performing data processing in accordance with a quantity measured by the sensor 131. The communication/data processing section 134 is supplied with the clock signal from the oscillator 133 and performs data processing or the like at a speed corresponding to the frequency of the received clock signal.

The communication/data processing section 134 also monitors the temperature measured by the sensor 131. The communication/data processing section 134 determines how often this monitoring should be performed, according to the temperature measured by the sensor 131.

Specifically, the communication/data processing section 134 includes a receiving section 134a, an A/D converter 134b, a data processing/recording section 134c, and a transmitting section 134d.

The receiving section 134a receives a signal from the reader/writer 150 through the antenna 110 and outputs a signal (a demodulated signal S7) obtained by demodulating the received signal (the antenna signal S2) to the data processing/recording section 134c.

The A/D converter 134b converts the output of the sensor 131 to a digital value (a digitized sensor signal S9).

The data processing/recording section 134c detects command information contained in the demodulated signal S7 and carries out data processing according to the detected command information. Then, if the results of the data processing show that it is necessary to make a response to the reader/writer 150, the data processing/recording section 134c produces a transmitting signal S8 containing the response information.

The data processing/recording section 134c also monitors the temperature measured by the sensor 131 with frequency corresponding to the temperature measured by the sensor 131.

In this embodiment, when the temperature measured by the sensor 131 satisfies the first condition, the data processing/recording section 134c performs operation (first operation) in which the measured temperature is monitored most frequently. When the temperature measured by the sensor 131 meets the second condition, the data processing/recording section 134c performs operation (second operation) in which the measured temperature is monitored with less frequently as compared with the case where the first condition is satisfied. When the temperature measured by the sensor 131 meets the third condition, the data processing/recording section 134c stops the regular monitoring of the measured temperature (third operation).

The data processing/recording section 134c also performs data processing on the measured quantity obtained from the sensor 131. Examples of the data processing include, e.g., outputting of the measured quantity to the reader/writer 150, and recording of the measured quantity.

The transmitting section 134d modulates the transmitting signal S8 and transmits the modulated signal to the reader/writer 150 through the antenna 110.

### Operation of the Data Carrier 100

For instance, when the temperature measured by the sensor 131 is equal to or higher than 20° C. but lower than 30° C. (the second condition), the oscillator 133 supplies the data processing/recording section 134c with a clock signal whose frequency is lower than that of a clock signal supplied when the first condition is satisfied. In this case, monitoring of the sensor 131 is carried out less frequently as compared with the case where the first condition is satisfied. Thus, in this temperature range, power consumption is reduced as compared with the case where the first condition is satisfied.

Thereafter, if the measured temperature becomes equal to or higher than 30° C. (the first condition), for example, the frequency of the clock signal output from the oscillator 133 is increased, and the operating speed of the data processing/recording section 134c is enhanced accordingly. And the monitoring of the sensor 131 by the data processing/recording section 134c is also conducted more frequently.

If the measured temperature becomes lower than 20° C. (the third condition), for example, the frequency of the clock signal output from the oscillator 133 is further decreased as compared with the case where the second condition is satisfied, such that the processing speed of the data processing/recording section 134c is lowered as well. And the data processing/recording section 134c stops the regular monitoring of the temperature measured by the sensor 131. Hence in this temperature range, a further reduction in power consumption is achievable as compared with the case where the second condition is satisfied.

As described previously, in this embodiment, the frequency of the clock signal supplied to the communication/data processing section 134, whether or not the clock signal should be supplied to the communication/data processing section 134, and how often the sensor 131 is monitored are changed depending on the degree of need to observe changes in the measured temperature. It is therefore possible to prevent data processing from being performed based on a clock signal whose frequency is higher than necessary. This results in a reduction in unnecessary power consumption in the data carrier 100, allowing greater power savings to be achieved. In particular, in the data carrier 100 whose steady state satisfies the second or third condition, a greater reduction in power consumption is expected, which enables the life of the battery to be increased.

### Second Embodiment of the Invention

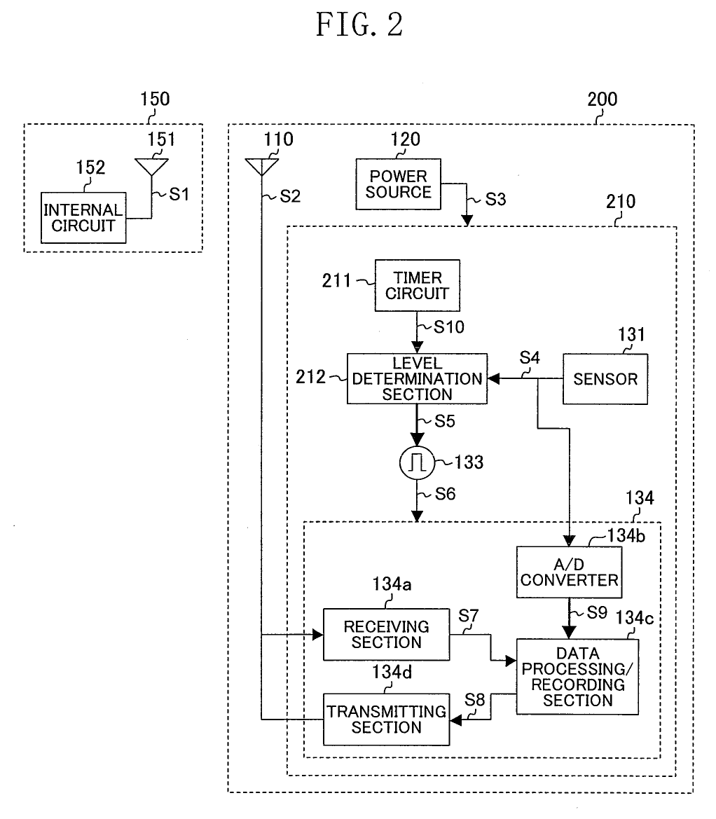

FIG. 2 is a block diagram illustrating the structure of a data carrier 200 according to a second embodiment of the invention. The data carrier 200 like the data carrier 100 performs two-way wireless communication with a reader/writer 150.

The data carrier 200 differs from the data carrier 100 in that not only a quantity itself measured by a sensor 131 but also the rate of change of the measured quantity are taken into account to determine the degree of need to monitor the sensor (i.e., how often monitoring should be performed). To be specific, the data carrier 200 is configured by replacing the operation section 130 with an operation section 210. And the operation section 210 is configured by replacing the level determination section 132 in the operation section 130 with a level determination section 212 and by adding a timer circuit 211.

The timer circuit 211 produces a signal (a determination timing signal S10) having a period T (e.g., T=1 minute) and outputs the produced signal to the level determination section 212.

The level determination section 212 determines, at certain intervals, which one of the conditions (which will be described later) that have been set based on one or both of the temperature measured by the sensor 131 and the rate of change of the measured temperature is satisfied, and according to the determination results, outputs a signal (a determination signal S5) for controlling the oscillation frequency of an oscillator 133. In controlling the oscillation frequency, the oscillation operation of the oscillator 133 may also be stopped so as to make the oscillation frequency become zero.

The above-described conditions are used to determine the degree of need to monitor the sensor (i.e., how often monitoring should be performed). In this embodiment, the following three conditions are set: a first condition in which the temperature measured by the sensor 131 is equal to or higher than a first threshold temperature (e.g., 20° C.) and changes in the temperature during a specified period of time (for example., T=1 minute, as described above) are equal to or greater than a second threshold temperature (e.g., 1° C.), a second condition in which the temperature measured by the sensor 131 is equal to or higher than the first threshold temperature, and changes in the temperature during the specified period of time are smaller than the second threshold temperature, and a third condition in which the temperature measured by the sensor 131 is lower than the first threshold temperature.

That is, the level determination section 212 determines the degree of need to monitor the sensor (how often monitoring should be performed) according to the amount of temperature change (the rate of temperature change) during the specified period of time and the temperature measured by the sensor 131.

To be specific, in order to measure the amount of change in the signal level of a sensor signal S4 in each period T, the level determination section 212 produces a differential signal of the sensor signal S4 by using a differentiating circuit, and determines the voltage level of the differential signal in accordance with timing provided by the determination timing signal S10.

In this example, since it is also sufficient for the level determination section 212 to output the three different determination results to the oscillator 133, the determination signal S5 may be 2 bits wide.

In this embodiment, the structure described above enables the following operation: when the amount of temperature change falls within a range indicating that observations should be made, the measured temperature is monitored most frequently while a clock signal having a higher frequency is supplied, and when the amount of temperature change falls within a range indicating that there is less need for observations, the sensor 131 is monitored less frequently while the frequency of the clock signal is reduced. Thus in this embodiment, it is also possible to prevent data processing from being performed based on a clock signal whose frequency is higher than necessary. As a result, a reduction in unnecessary power consumption in the data carrier 200 is achievable.

In the first and second conditions, for example, the level determination section 212 of this embodiment takes into account both the temperature measured by the sensor 131 and the rate of change of the temperature as the conditions for the determination, but the determination may be made by using the temperature change rate alone.

### Third Embodiment of the Invention

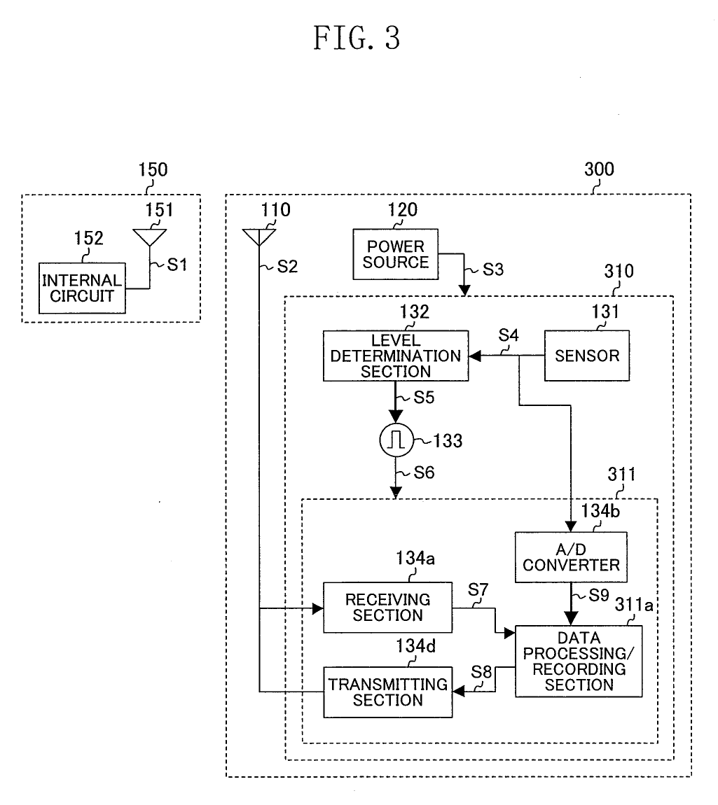

FIG. 3 is a block diagram illustrating the structure of a data carrier 300 according to a third embodiment of the invention. The data carrier 300 like the data carrier 100 performs two-way wireless communication with a reader/writer 150.

The data carrier 300 differs from the data carrier 100 in that a data processing/recording section is configured so as to be able to perform different data processing depending on a temperature measured by a sensor. To be specific, the data carrier 300 is configured by replacing the data processing/recording section 134c in the data carrier 100 with a data processing/recording section 311a. That is, as shown in FIG. 3, in the data carrier 300, a communication/data processing section 311 includes a receiving section 134a, an A/D converter 134b, a transmitting section 134d, and the data processing/recording section 311a. And an operation section 310 includes a sensor 131, a level determination section 132, and the communication/data processing section 311.

The data processing/recording section 311a has the same function as the data processing/recording section 134c, while including tables (hereinafter referred to as “processing tables”) which specify responses that correspond to the respective three conditions (i.e., the first to third conditions) described in the first embodiment and that are performed when those conditions are satisfied.

Specifically, if the measured temperature satisfies the first condition (in the above-described example, if the measured temperature is equal to or higher than 30° C.), the data processing/recording section 311a performs data processing specified in a first processing table. If the measured temperature satisfies the second condition (in the above-described example, if the measured temperature is equal to or higher than 20° C. but lower than 30° C.), the data processing/recording section 311a performs data processing specified in a second processing table. If the measured temperature satisfies the third condition (in the above-described example, if the measured temperature is lower than 20° C.), the data processing/recording section 311a performs data processing specified in a third processing table.

The responses specified in the processing tables may include one in which no data processing is performed. Such a response is carried out by leaving a processing table blank, for example.

Furthermore, in this embodiment, oscillation frequencies for the oscillator 133 that correspond to the first, second, and third conditions, respectively, are set based on the amounts of data processing corresponding to the respective processing tables. Specifically, the oscillation frequencies fl, f2, and f3 for the oscillator 133 corresponding to the first, second, and third conditions, respectively, are set so as to have values that satisfy the following expression (1) where R1 is the amount of data processing corresponding to the first processing table, R2 is the amount of data processing corresponding to the second processing table, and R3 is the amount of data processing corresponding to the third processing table.

$$\frac{f 1}{R 1} = \frac{f 2}{R 2} = \frac{f 3}{R 3} \qquad ( 1 )$$

If the oscillation frequencies for the oscillator 133 are set in this way, data processing is always completed in a given time irrespective of the amount of data processing assigned for each of the first to third conditions, while the data processing is prevented from being performed in accordance with a clock signal having a frequency higher than necessary.

It is desired that an upper limit be placed on the frequency of the clock signal S6 so as to avoid a situation in which when the amount of data processing is large, the frequency of the clock signal S6 becomes excessively high to cause the data carrier 300 to consume more power such that the power consumption exceeds the chip's allowable power dissipation or the operational reliability of the entire circuit is reduced.

In this embodiment as in the data carrier 200 of the second embodiment, the determination may be made based on both the temperature measured by the sensor 131 and the rate of change of the temperature or based on the rate of change of the temperature so as to change the frequency of the clock signal S6, how often the sensor 131 should be monitored, etc.

In the examples described in the foregoing embodiments, the power source 120 is a battery, but power may be supplied in a different way. For instance, power may be obtained from the antenna signal S2 received by the antenna 110, and the obtained power may be supplied to the operation section.

Also, the sensor 131 is not limited to the temperature sensor shown by example. Other sensor, for example, an optical sensor, may be adopted.

As described previously, the data carriers according to the invention, which produce the effect that a greater reduction in power consumption is achievable, are applicable to data carriers (for example, non-contact IC cards, non-contact tags, etc.) which communicate with readers/writers.

What is claimed is:

1. A data carrier for communicating with a reader/writer, comprising:
a sensor;
a level determination section for determining the degree of need to monitor the sensor in accordance with a plurality of conditions set based on one or both of a measured quantity obtained from the sensor and the rate of change of the measured quantity, and outputting a determination signal according to a result of the determination;
a receiving section for receiving command information from the reader/writer;
a data processing/recording section for performing data processing on the measured quantity and the command information;
a transmitting section for transmitting a signal corresponding to a result of the data processing to the reader/writer; and
an oscillator for supplying a clock signal at least to the data processing/recording section,
wherein the oscillator is configured so that the oscillation frequency thereof is controlled in accordance with the determination signal.

2. The data carrier of claim 1, wherein when the frequency of the clock signal is controlled to be zero, power supply to the oscillator is shut off.

3. The data carrier of claim 1, wherein the sensor is a temperature sensor.

4. The data carrier of claim 1, wherein the data processing/recording section includes processing tables, each specifying a response that corresponds to one of the plurality of conditions and that is performed when the one of the plurality of conditions is satisfied, and is configured so as to perform data processing based on one of the processing tables that corresponds to the satisfied condition.

5. The data carrier of claim 1, wherein the highest level to which the frequency of the oscillator is settable is limited.
